(19) United States
(12) Patent Application Publication
(10) Pub. No.: US 2022/0355298 A1
(43) Pub. Date: Nov. 10, 2022

(54) A MICROFLUIDIC ANALYSER

(71) Applicants: CENTRE FOR CELLULAR AND MOLECULAR PLATFORMS, Bangalore (IN); INDIAN INSTITUTE OF TECHNOLOGY, Chennai (IN)

(72) Inventors: Taslimarif SAIYED, Bangalore (IN); Preksha GUPTA, Bangalore (IN); Anil PRABHAKAR, Chennai (IN); Ambili MOHAN, Chennai (IN)

(73) Assignees: CENTRE FOR CELLULAR AND MOLECULAR PLATFORMS, Bangalore (IN); INDIAN INSTITUTE OF TECHNOLOGY MADRAS, Chennai (IN)

(21) Appl. No.: 17/624,483

(22) PCT Filed: Jul. 3, 2020
(86) PCT No.: PCT/IB2020/056297

§ 371 Date: Jan. 3, 2022

(30) Foreign Application Priority Data
Jul. 3, 2019 (IN) 201941026590

(51) Int. Cl. B01L 3/00; G01N 15/14

(52) U.S. Cl. CPC B01L 3/502776; G01N 15/1484; G01N 15/1459; G01N 15/1404; B01L 2200/0636; B01L 2200/0652; B01L 2300/0654; B01L 2200/16; G01N 2015/1481; G01N 2015/1006

(57) ABSTRACT

A microfluidic analyser and a method of using the same is disclosed. The microfluidic analyser comprising a droplet generator, an analyte flow channel in fluid communication with said droplet generator at a first end, wherein said flow channel is configured to allow the droplets to flow in from the first end and exit from a second opposing end, said flow channel receiving at least one illumination channel positioned at a predetermined location between the first and the second end to excite contents of the droplets and said flow channel further comprising a plurality of receiving channels set at predetermined angles to an axis of the flow channel to interrogate at least one optical signal from the illuminated droplet traversing the flow channel and wherein said receiving channels terminate in a signal detector at the distal end away from the flow channel.

### TECHNICAL FIELD

The present invention pertains to the field of microfluidic analysers. In particular, the present invention pertains to the field of microfluidic analysers that provide read-outs by optically interrogating analyte samples in droplets.

### BACKGROUND OF THE INVENTION

It is well known that optical interrogation of biological and analyte samples can provide meaningful insights into their composition or pathophysiological states. Currently, there are several commercially available flow cytometers in the market measuring scattered and emitted light from biological samples. However, these machines are expensive, require high operational power, are bulky to cater to point-of-care roles and require skilled man-power to run the tests and interpret results. Envisaging these drawbacks, several attempts have been made to develop commercially viable analysers based on microfluidic platforms which enable analysis of very miniscule quantities of samples. Microfluidic devices also open avenues for high throughput cell/analyte screening, single cell analysis and rare event identification. A microfluidics based flow analyser will allow effective decentralized point-of-care diagnostics where patient samples like blood or body-fluids can be screened for infections, malignancies and other pathophysiological conditions rapidly.

One such invention has been described by the instant inventors in their PCT Application PCT/IB2013/050871 filed on 1 Feb. 2013 which is incorporated by reference herein in its entirety. It describes a microfluidic flow analyser having a plurality of buffer channels and a sample channel, so arranged that the sample flowing through the central flow channel is interrogated by laser thereby exciting any cells traversing through the flow channel to generate optical signals which are then captured and interpreted by sensors placed at predetermined locations. These optical signals are then sent to a computing unit for detection of infection. The design however, is limited in its ability to interrogate each and every event/cell/particle/analyte in the sample. The existing device also is limited in its ability to detect multiple fluorescent signals from cells excited by a single laser source. Dynamic range of detection can be enhanced by using multiple detectors. However, this addition of multiple lasers and optical detectors increases the bulk, complexity and cost of such devices.

These and other disadvantages have been addressed in the instant invention wherein the improvements consists of measuring optical signals, including and not limited to, absorbance, size scatter, and multiple fluorescence signals from each and every analyte/cells/beads/particles within/without water-in-oil droplets. Furthermore, the measurement of multiple fluorescence signals is achieved by using a single laser source with a single detector.

### SUMMARY OF THE DISCLOSURE

The present disclosure solves the limitations of existing techniques and comprises of multi-system approach for encapsulation of analytes/cells/beads/particles enclosed within water-in-oil droplets or emulsions and their multi-parametric optical interrogation.

The invention comprises a microfluidic chip comprising of a central flow channel for a biological sample/analyte to flow through and be interrogated by laser source(s) thereby exciting the cells or analyte therein. A feature of the invention is the ability to encapsulate single cells or analyte samples within water-in-oil droplets/emulsions for optical interrogation. This method allows encapsulation and interrogation of each and every cell/analyte even in very small working volumes. It overcomes the drawbacks of conventional devices which cannot handle small volumes of samples (as is common for biological samples), have to dispense large volumes of sheath fluid for analysis and fail to interrogate each and every cell/particle/analyte in the sample. The size of droplets and encapsulation of the sample within them can be controlled by manipulating the flow rates of sample with respect to oil and by changing the sample concentration. Droplets can thus be generated that encapsulate just a single cell per droplet. These droplets move down the flow-channel and are illuminated by the laser(s) or another optical source coupled into plurality of optical fibres with or without lensed tips. The optical signals coming off the droplets, be it forward scatter, side scatter, fluorescence or absorption are acquired by another set of optical fibres, coupled into a detector and electronically processed to obtain the read-out. The optical fibres are inserted in side channels placed at specific angles and distances from the central channel and separated from each other by a specific distance. The use of lensed-tip optical fibres and there placement very close to the central flow channel allows precision optical interrogation of the droplets and their contents without the need of complicated open-space optical lens systems.

Another novel feature of the device is that a combination of single excitation (laser/light) source and a single detector can be used to measure multiple fluorescence (and other optical signals) signals of different wavelengths emanating from the same sample droplet. This is achieved by interpreting optical signals from successive signal acquisition points traversed by the sample or analyte in the flow channel and factoring in the time delay to track and analyze single cell or analyte and subsequently combining all these signals using optical components into a single detector.

This disclosure provides a method for the detection of biological and non-biological parameters using optical signals from samples/analytes. The method can be used for but not limited to biomedical research, healthcare applications, environmental applications, agricultural and animal biotechnology applications, material science applications, high-throughput screening, single cell analysis and rare event identification. The invention has several other advantages over contemporary microfluidic analysers. It provides simultaneous detection of not only size scatter and multiple fluorescence signals but also absorbance which is not possible in conventional flow cytometers. The design is a plug-and-play setup and allows customization of optical components depending on the particular need of the assay. The microfluidic chip can be easily fabricated in PDMS or other material for large-scale production. The device is cost-effective, portable and can be used in a point-of-care setting, is amenable to scale-up and mass-production, obviates patterning wave-guides into the chip thereby easing manufacture and can be used to interpret a plurality of optical signals. This and other features will be described in greater detail in the following pages, which is meant for illustrative purposes alone and therefore must not be construed to be limiting the invention in any way.

### BRIEF DESCRIPTION OF THE ACCOMPANYING FIGURES

The figures presented below are provided for illustrative purposes and in no way limit the scope of the design and invention.

FIG. 1. depicts a schematic view of the droplet based multiplex microfluidic analyser setup.

FIG. 2. shows the arrangement of laser source and optical signal acquisition points of the device to collect and process for 3 colour fluorescence detection.

FIG. 3. Multiplexed fluorescence detection using an embodiment of the said invention.

FIG. 4. Droplet absorbance signals form droplets containing varying dilutions of a colorimetric reagent compared with droplets containing water

### SPECIFIC EMBODIMENTS OF THE INVENTION

The present disclosure has been made in an effort to resolve the above-described problems associated with the prior art.

Accordingly, the present invention is directed to a microfluidic analyser comprising a droplet generator, an analyte flow channel in fluid communication with said droplet generator at a first end, wherein said flow channel is configured to allow the droplets to flow in from the first end and exit from a second opposing end, said flow channel receiving at least one illumination channel positioned at a predetermined location between the first and the second end to excite contents of the droplets and said flow channel further comprising a plurality of receiving channels set at predetermined angles to an axis of the flow channel to interrogate at least one optical signal from the illuminated droplet traversing the flow channel and wherein said receiving channels terminate in a signal detector at the distal end away from the flow channel.

In another preferred embodiment, the present invention is directed to microfluidic analyser(s), wherein the droplet generator comprises an analyte inlet fluidically coupled with an analyte source, a buffer inlet fluidically coupled with a buffer source, an analyte inlet channel in fluid communication with the analyte inlet at a first end to receive analyte, a buffer inlet channel in fluid communication with the buffer inlet at a first end to receive buffer, a junction receiving a second end of said analyte channel and a second end of buffer channel, said junction configured to allow interaction of received analyte and buffer, said junction further comprising a constricted fluid path configured to generate droplets to flow into the flow channel.

In yet another preferred embodiment, the present invention is directed to microfluidic analyser(s), wherein at least one illumination channel and receiving channels comprises an optical waveguide.

In yet another preferred embodiment, the present invention is directed to microfluidic analyser(s), wherein at least one waveguide is an optical fibre.

In yet another preferred embodiment, the present invention is directed to microfluidic analyser(s), wherein the waveguide is coupled to an optical source.

In yet another preferred embodiment, the present invention is directed to microfluidic analyser(s), wherein at least one optical fibre comprises a lensed tip.

In yet another preferred embodiment, the present invention is directed to microfluidic analyser(s), further comprising a computing unit capable of receiving at least one optical signal detected by the signal detector and analyzing the received optical signal.

In yet another preferred embodiment, the present invention is directed to microfluidic analyser(s), wherein the droplet generator is coupled to at least one pump to control flow rate in the analyte flow channel.

In yet another preferred embodiment, the present invention is directed to microfluidic analyser(s), wherein the droplet generator is coupled to at least one pump to control droplet size.

In vet another preferred embodiment, the present invention is directed to microfluidic analyser(s), wherein the droplet generator comprises a feedback control configured to optimize flow rate of droplets based on at least one optical signal from an illuminated droplet.

In yet another preferred embodiment, the present invention is directed to method using a microfluidic analyser comprising, receiving analyte and buffer by a droplet generator, wherein the analyte and the buffer interact to form at least one droplet flowing into an analyte flow channel, said analyte flow channel in fluid communication with said droplet generator at a first end, wherein said flow channel is configured to allow the droplet to flow in from the first end and exit from a second opposing end, illuminating the said droplet through at least one illumination channel, interrogating optical signals from the illuminated droplet traversing the flow channel through at least one receiving channel, detecting at least one optical signal from the illuminated droplet by at least one signal detector coupled to plurality of receiving channels, analysing the detected optical signal to determine at least one property of contents of the droplet.

In yet another preferred embodiment, the present invention is directed to method(s), wherein a droplet in the analyte flow channel is illuminated by a single optical source through plurality of illuminating channels such that the droplet is subjected to plurality of interrogations by same wavelength of the optical source at plurality of locations, and wherein the interrogations are separated by a time delay based on flow rate of the droplet across the locations.

In yet another preferred embodiment, the present invention is directed to method(s), wherein the optical signals from an illuminated droplet comprises a plurality of optical wavelengths.

In yet another preferred embodiment, the present invention is directed to method(s), wherein flow rate of a droplet is optimized by a feedback control configured to optimize flow rate of the droplet based on at least one optical signal detected from an illuminated droplet.

In yet another preferred embodiment, the present invention is directed to method(s), wherein plurality of optical signals is successively interrogated at plurality of locations traversed by a droplet and the plurality of optical signals from the droplet are analysed by combining the plurality of optical signals into a detector.

In yet another preferred embodiment, the present invention is directed to method(s), wherein flow rate of droplets is optimized to interrogate optical signals from successive droplets such that a droplet is interrogated after a succeeding droplet has traversed all the plurality of locations of interrogation.

In yet another preferred embodiment, the present invention is directed to method(s), wherein the analyte is selected from a group comprising blood cells, single cells from culture cell lines, serum, bacteria, contaminants in liquid, fluorescently labeled cells, beads, microparticles, fluorescently tagged cell organelles, fluorescently tagged nucleic acid probes, and fluorescently tagged nucleic acid proteins.

In yet another preferred embodiment, the present invention is directed to method(s), wherein the buffer is selected from a group comprising oils, surfactants and emulsifiers.

### DETAILED DESCRIPTION OF THE DISCLOSURE

Flow cytometry broadly measures and analyzes the optical signals emanating from particles flowing in a liquid stream through a beam of light. Through a configuration of precision-alignment of both fluidic stream and optical components, the system can detect individual cells in a sample very rapidly. It is more sensitive and specific in comparison to other biological detection and analytical systems in prevalence and has gained preference in clinical (including diagnostic and monitoring), scientific and engineering fields.

Even though flow cytometers have these positive attributes mentioned above, they are complex, bulky and expensive, rendering the technology not as pervasive as it should be. It would be advantageous in resource-limited settings if the components were smaller and less expensive. The precision with which optical signals have to be generated and acquired also requires sophistication and therefore skilled human-resource is required to run and interpret analytical samples. Attempts have been made using microfluidic chips wherein the samples were loaded with buffers forming a sheathing fluid and sent via a flow channel wherein they are interrogated with lasers. The optical interrogation in these devices, however, relied on the use of expensive microscope attached high-speed cameras, on-chip lens systems and waveguides which are not simple enough to use in a large-scale context for example in point-of-care diagnostics. Microscope attached camera systems are expensive and lack sensitivity to detect fluorescence signals from biological samples at lower concentrations. Similarly, on-chip lens systems and waveguides are more complex to fabricate precluding their usage in above mentioned applications. Moreover, current microfluidic platforms are limited in their capacity to detect multiple optical parameters from the same cell/analyte. Standard diagnostic tests and other assays often require multiparametric analysis for effective usage. This can be achieved by incorporating multiple light/laser sources and corresponding increase in detectors. However, this will add to the bulkiness and cost of the device and again make them unsuitable for large scale use.

The instant invention provides a microfluidic analyser comprising a droplet generator, an analyte flow channel in fluid communication with said droplet generator at a first end, wherein said flow channel is configured to allow the droplets to flow in from the first end and exit from a second opposing end, said flow channel receiving at least one illumination channel positioned at a predetermined location between the first and the second end to excite contents of the droplets and said flow channel further comprising a plurality of receiving channels set at predetermined angles to an axis of the flow channel to interrogate at least one optical signal from the illuminated droplet traversing the flow channel and wherein said receiving channels terminate in a signal detector at the distal end away from the flow channel.

In accordance with an embodiment, the droplet generator comprises an analyte inlet fluidically coupled with an analyte source, a buffer inlet fluidically coupled with a buffer source, an analyte inlet channel in fluid communication with the analyte inlet at a first end to receive analyte, a buffer inlet channel in fluid communication with the buffer inlet at a first end to receive buffer, a junction receiving a second end of said analyte channel and a second end of buffer channel, said junction configured to allow interaction of received analyte and buffer, said junction further comprising a constricted fluid path configured to generate droplets to flow into the flow channel.

The droplet generator is coupled to at least one pump to control flow rate in the analyte flow channel. The droplet generator is coupled to at least one pump to control droplet size. The droplet generator comprises a feedback control configured to optimize flow rate of droplets based on at least one optical signal from an illuminated droplet.

In accordance with an embodiment, the microfluidic analyser further comprises a computing unit capable of receiving at least one optical signal detected by the signal detector and analyzing the received optical signal. The optical signal may be one or more of light scatter, fluorescence signals of different wavelengths and intensities, absorbance, luminescence etc.

In accordance with an embodiment, at least one illumination channel and receiving channel comprises an optical waveguide. The waveguide is coupled to an optical source. The optical source may be a laser source. The optical waveguide may be an optical fibre comprising a lensed tip.

By way of an example, the microfluidic analyser comprises a microfluidic chip consisting of a combination of at least one analyte inlet and one oil/non-aqueous inlet channels meeting at a junction to produce emulsions/water-in-oil droplets. Droplet formation, including size and speed, is controlled by modulating the flow rate of analyte and oil using pumps and can be changed by changing the size, geometry of the junction and channels. The droplets flow into the analyte flow channel and encounter a plurality of illumination channels placed at specified angles to the direction of flow at points of optical interrogation. Lensed and non-lensed optical fibres can be inserted into these fibre channels. At least one optical fibre is coupled to an optical source to illuminate a cross-section of analyte flow channel with droplets passing through it. At least one optical fibre is coupled to a detector for collecting optical signals originating from the illuminated droplet and its constituents (FIG. 1). The collected optical signals from the detectors are converted into digital signals using electronic boards and used for analysis.

In one embodiment of the invention, the microfluidic analyser comprises fabricated chip that has pre-aligned insertion points for optical fibres for illumination and optical data collection. All the microfluidic channels are of uniform height making the chip easy to fabricate and allowing, large-scale production.

In another embodiment, lensed-tip optical fibres are used for optical illumination of droplets and their constituents which provides a very narrow path of light for illumination. A combination of lensed and non-lensed fibres can be used for illumination depending on the optical signal needed to be interrogated.

In one embodiment, fibre channels are placed at different angles around the illumination channel. Detection of optical signals is performed using the fibre channels and multiparametric analysis can be done depending on the optical information collected at different angles which includes but is not limited to the measurement of light scatter at smaller and larger angles, fluorescence signals of different wavelengths and intensities, absorbance, luminescence etc.

In one embodiment, cells/particles can be encapsulated in droplets and optically interrogated along the analyte flow channel. The number of cells/particles encapsulated depends on the sample concentration and the relative flow rates of sample and oil in relation to the device geometry in terms of channel width, height and nozzle constriction but not limited to it. Optical signals including light scatter signals from droplets can further be used to count the number of cells/particles encapsulated within each droplet up to the resolution limit of the device.

In another embodiment of the analyser, optical sources including but not limited to lasers with wavelengths ranging from UV to infrared can be coupled to optical fibres to interrogate the sample traversing the flow channel. In yet another embodiment, a single laser light source can be split into multiple optical fibres by mechanisms like two or three-way (or more) splitters (but not limited to it), to interrogate the sample.

In another embodiment, the device also incorporates filters and Bragg gratings to filter out laser light of specific wavelengths and thereby enhance the signal to noise ratio.

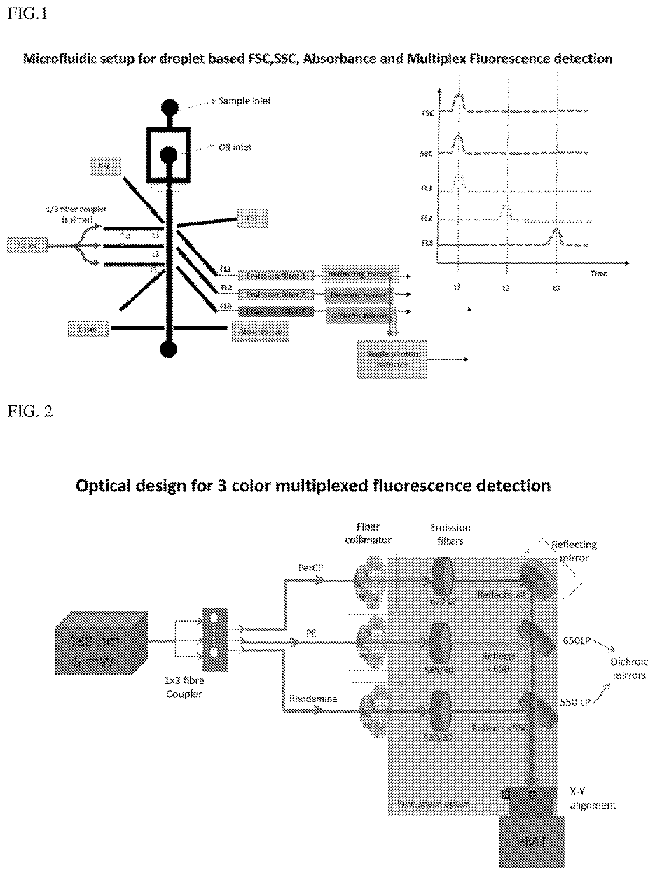

In yet another embodiment, the microfluidic analyser can be used for interrogating multiple fluorescence signals originating from the same droplet/cell/particle/analyte using a single laser for excitation and a single detector for collecting light of different wavelengths. This is achieved by splitting the single laser output into multiple optical fibres placed at specified distances from each other so that the same droplet is interrogated by same wavelength of light at multiple points separated by a corresponding time delay based on flow of the same droplet from one point to the next. Optical signals from each of the points of interrogation are collected into the respective collection channels via optical fibres and the time delayed signals are combined using a set of filters, reflecting and dichroic mirrors into a single detector. This novel multiplex feature significantly reduces cost and bulkiness of the analyser (FIG. 2).

In another embodiment of the invention, time-delay is factored into the optical signal acquisition data received from successive optical signal detectors positioned down-stream of the flow-channel so as to enable assigning the scatter signal to its originator cell/analyte particle traversing between those detection points in the flow-channel. Since each cell can be tracked, the device is able to capture even those very rare events, which otherwise would be missed without this degree of resolution. Given the close proximity of the optic fibres to the central channel, even very low intensity fluorescence signals can be picked up. Thus this device can also be used for highly sensitive high-throughput single cell screening and rare event identification in samples.

In another embodiment of the invention, samples or analytes can be interrogated simultaneously by multiple optical signals including lights of differing wave-lengths, Lasers and fluorescence to acquire a plurality of scatter, absorbance and fluorescence values.

In yet another embodiment of the invention, two lights with different wavelengths can be converged onto a single interrogation point on the flow channel.

In yet another embodiment of the invention, the received signal is post-processed using a plurality of nonlinear noise-reduction algorithms to enhance the ability to identify and classify cells/particles/analytes based upon their light scattering, absorbance and fluorescence properties.

A method using a microfluidic analyser is also disclosed. The method comprises, receiving analyte and buffer by a droplet generator, wherein the analyte and the buffer interact to form at least one droplet flowing into an analyte flow channel, said analyte flow channel in fluid communication with said droplet generator at a first end, wherein said flow channel is configured to allow the droplet to flow in from the first end and exit from a second opposing end, illuminating the said droplet through at least one illumination channel, interrogating optical signals from the illuminated droplet traversing the flow channel through at least one receiving channel, detecting at least one optical signal from the illuminated droplet by at least one signal detector coupled to plurality of receiving channels, analysing the detected optical signal to determine at least one property of contents of the droplet.

In accordance with an embodiment, a droplet in the analyte flow channel is illuminated by a single optical source through plurality of illuminating channels such that the droplet is subjected to plurality of interrogations by same wavelength of the optical source at plurality of locations, and wherein the interrogations are separated by a time delay based on flow rate of the droplet across the locations. The optical signals from an illuminated droplet comprise plurality of optical wavelengths. The plurality of optical signals is successively interrogated at plurality of locations traversed by a droplet and the plurality of optical signals from the droplet are analysed by combining the plurality of optical signals into a detector.

In accordance with an embodiment, flow rate of a droplet is optimized by a feedback control configured to optimize flow rate of the droplet based on at least one optical signal detected from an illuminated droplet. The flow rate of droplets is optimized to interrogate optical signals from successive droplets such that a droplet is interrogated after a succeeding droplet has traversed all the plurality of locations of interrogation.

The analyte is selected from a group comprising blood cells, single cells from culture cell lines, serum, bacteria, contaminants in liquid, fluorescently labeled cells, beads, microparticles, fluorescently tagged cell organelles. The buffer is selected from a group comprising oils, surfactants and emulsifiers.

Some of the features of the invention and the methods of operation are illustrated in the following examples and are provided to aid the reader get a better understanding of the invention. These examples are illustrative and must not be construed as limiting the scope of the invention in any manner.

### EXAMPLE 1

As shown in FIG. 1, the schematic outlines the construction and functioning of the droplet based multiplex microfluidic analyser. The microfluidic chip can be fabricated in poly(dimethylsiloxane) [PDMS] and has microchannels. There are at least two inlets—one for sample and another for oil. The sample and oil inlet channels meet at a nozzle junction to produce droplets of water-in-oil because of phase separation. The flow rate of the sample and oil can be controlled using infusion pumps to obtain water-in-oil droplets. The droplets then flow through the central flow channel wherein they are optically interrogated. By using samples containing single-cell suspension, and by controlling the flow-rate droplets encapsulating single cells can be obtained.

The flow channel is flanked by a plurality of illuminating side channels downstream of the nozzle junction, where optical fibres can be inserted. These illuminating channels are filled with index-matching fluid to compensate for refractive aberrations as light crosses the tip of the fibre into the chip medium. The illuminating channels may be fed from a single or multiple optical sources. Same optical source can feed multiple optical fibres by the use of multi-way splitter. Interrogation of the sample may be done at any wavelength.

The optical signal acquisition channels house Photomultiplier tube (PMT)/photodiode/SPCM-coupled optical fibres placed around the flow channel at specific angles so as to pick up required optical signals efficiently. Each acquisition microchannel is inlaid at a pre-calibrated angle relative to the axis of its assigned optical source so as to detect and quantitate any forward scatter, side scatter or signal absorption induced by the cell or particle that is being interrogated. These are so positioned relative to the axes of each optic signal source, to detect absorption (0 degree), forward scatter (5 or 10 degrees), side-scatter (45 and 135 degrees). Similarly, fluorescence acquisition is also enabled by detectors positioned at 45 and 135 degrees.

The emissions from excited cells/sample particle in each droplet are detected and quantified by detectors as it transits downstream past respective signal detectors. The signal is collected and analysed using electronic circuits, visualized and interpreted using algorithms such as Python-based GUI. The time lag when a droplet sequentially encounters the first and each successive detector optical fibre is factored into the computation enabling assignment of each signal output to its single respective originator cell/particle.

### EXAMPLE 2

Working of the Multiplexed MFA:

The sample containing the analyte or cells is first prepared. As shown in FIG. 1, ideally, single-cell suspension is prepared and loaded into a syringe pump to be introduced into the inlet of the flow channel. Similarly, oil is loaded into syringe pumps that would be introduced via the microchannels to the flow channel inlet as well. By regulating the flow-rate of the two, water-in-oil droplets encapsulating cells or analyte particles are generated and transit from the inlet along the axis of the flow channel. The illuminating channels are pre-filled with appropriate Index matching fluid. Laser source of a selected wavelength illuminate the sample at multiple points. The optical signals emanating from the excitation of the cells or particles are acquired by the single or multiple detectors located at predetermined positions about the flow-channel. The signals are collated, processed by computer and the results visualized.

While absorption is computed as the loss of signal caused by the encapsulated cell or particle compared against the output from an oil droplet devoid of said cell or particle, scatter signals are picked up by the detectors positioned at respective angles.

### EXAMPLE 3

The Multiplex Fluorescence Data Acquisition System

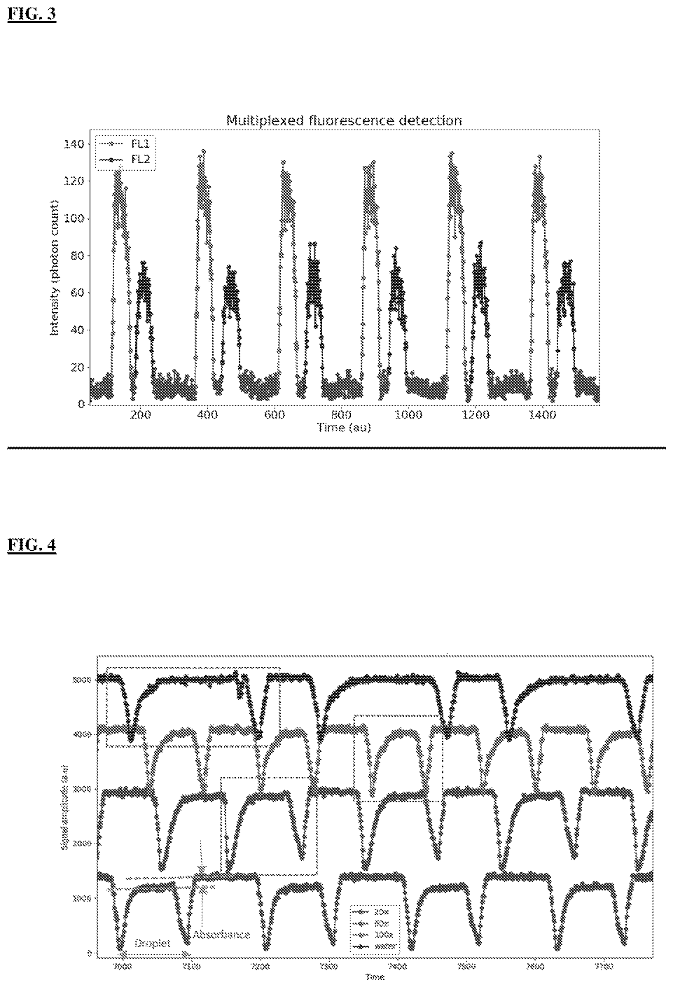

The same droplet is illuminated by a singular optical source as described above in example 1 and multitude of fluorescence signals from different fluorophores present within this droplet are detected at the array of parallelly placed combination of illumination and detection channels. These optical fibre channels are separated enough in space to allow a time delay in the fluorescence signal reaching the detector. The fibres are coupled to specific filters in order to collect/transmit light of only particular required wavelengths. These time delayed light signals are then combined into the same detector using a combination of reflecting and dichroic mirrors (FIG. 2). FIG. 3 represents an example of droplet fluorescence signals from a dual labeled droplet of varying intensities and wavelengths excited by a 488 nm laser.

### EXAMPLE 4

Absorbance Measurement

A droplet is illuminated by a singular light source described above in example 1 and a multitude of absorbance signals from different droplets are detected at the array of parallelly placed combination of illumination and detection channels. Absorbance is measured as the proportionate reduction in optical signals through a droplet containing colorimetric reagent as compared to a droplet containing water. FIG. 4 represents an example of droplet absorbance signals form droplets containing varying dilutions a colorimetric reagent compared with droplets containing water. Some applications of absorbance measurement include but not limited to measurement of hemoglobin in blood, measurement of contaminants in fluid, and measurement of HRP reaction end products from an ELISA.

Benefits of the Invention

The multiplexed microfluidic analyser thus has applications as an analytical equipment in different areas such as biomedical research, healthcare applications, environmental applications, agricultural and animal biotechnology applications, material science applications etc. It can be used to determine absorbance values of analytes including chemicals, dyes, cells and also to monitor colorimetric and enzymatic reactions among other possibilities. The device can detect and quantitate luminescent, bioluminescent and phosphorescent signals. Hence, using antibody-fluorophore labels against unique cell surface markers, the device can detect and count those cell-types from a sample. Similarly, the device can be used to detect and measure the fluorescence intensities from fluorescently tagged gene products, proteins, biomolecules etc. within a cell. In terms of diagnostics, the device should enable detection of aberrant cells based on differential expression of fluorescently tagged biomarkers or changes in absorbance properties of the cells or analytes. Beads or cell-based immunoassays can be carried out with a high degree of sensitivity and specificity using the device on very small volumes of sample fluids. Since droplet encapsulation allows control over interrogation of each analyte/cell, this microfluidic analyser is well suited for high-throughput single-cell analysis and rare event identification.

The invention disclosed in the instant application has several advantages over currently available microfluidic analysers. It is relatively cheaper, and portable. It enables multi-parametric analyses—for instance, the same device can provide interrogation of samples with laser light for scatter and absorption as well as fluorescence studies. It reduces the number of signal generation and signal acquisition components to fewer optical source and detector units, thereby drastically reducing the bulk, complexity and cost of the device. The chip design enables bulk manufacturing raising possibilities of economy-of-scale. The prefabricated channel-feature of the chip for provision and acquisition of optical signals, obviates sophisticated alignment procedures for the detectors to acquire optical signals and requires only insertion of the optical fibres into the acquisition channels. This, further makes the device facile to use while maintaining higher sensitivity and accuracy. These advantages make the device truly suited for a point-of-care use.

The design and operation of an efficient but simple droplet based multiplexed microfluidic analyser is described, which has an integrated optical excitation and detection system that is capable of performing flow cytometry measurements with the capacity of using a single laser source and a single photodetector for fluorescence intensity measurements of multiple wavelengths. The device employs a water-in-oil droplet encapsulation system for cells or particles for exposing them to the light stream, which allows interrogation of each analyte/particle/cell in the sample. This provides high-throughput single-cell analysis and rare event identification capabilities from even minute quantities of samples.

While different aspects and embodiments of the invention have been disclosed herein, it would be apparent to persons skilled in the art that many other embodiments and aspects are possible without departing from the spirit of the invention. Such other embodiments are therefore claimed to fall within the scope of the invention described herein.

1. A microfluidic analyser comprising a droplet generator, an analyte flow channel in fluid communication with said droplet generator at a first end, wherein said flow channel is configured to allow the droplets to flow in from the first end and exit from a second opposing end, said flow channel receiving at least one illumination channel positioned at a predetermined location between the first and the second end to excite contents of the droplets and said flow channel further comprising a plurality of receiving channels set at predetermined angles to an axis of the flow channel to interrogate at least one optical signal from the illuminated droplet traversing the flow channel and wherein said receiving channels terminate in a signal detector at the distal end away from the flow channel.

2. A microfluidic analyser of claim 1, wherein the droplet generator comprises an analyte inlet fluidically coupled with an analyte source, a buffer inlet fluidically coupled with a buffer source, an analyte inlet channel in fluid communication with the analyte inlet at a first end to receive analyte, a buffer inlet channel in fluid communication with the buffer inlet at a first end to receive buffer, a junction receiving a second end of said analyte channel and a second end of buffer channel, said junction configured to allow interaction of received analyte and buffer, said junction further comprising a constricted fluid path configured to generate droplets to flow into the flow channel.

3. A microfluidic analyser of claim 1, wherein at least one illumination channel and receiving channels comprises an optical waveguide.

4. The microfluidic analyser of claim 3, wherein at least one waveguide is an optical fibre.

5. The microfluidic analyser of claim 3, wherein the waveguide is coupled to an optical source.

6. The microfluidic analyser of claim 5, wherein at least one optical fibre comprises a lensed tip.

7. The microfluidic analyser of claim 1, further comprising a computing unit capable of receiving at least one optical signal detected by the signal detector and analyzing the received optical signal.

8. A microfluidic analyser of claim 1, wherein the droplet generator is coupled to at least one pump to control flow rate in the analyte flow channel.

9. A microfluidic analyser of claim 1, wherein the droplet generator is coupled to at least one pump to control droplet size.

10. A microfluidic analyser of claim 1, wherein the droplet generator comprises a feedback control configured to optimize flow rate of droplets based on at least one optical signal from an illuminated droplet.

11. A method using a microfluidic analyser comprising, receiving analyte and buffer by a droplet generator, wherein the analyte and the buffer interact to form at least one droplet flowing into an analyte flow channel, said analyte flow channel in fluid communication with said droplet generator at a first end, wherein said flow channel is configured to allow the droplet to flow in from the first end and exit from a second opposing end, illuminating the said droplet through at least one illumination channel, interrogating optical signals from the illuminated droplet traversing the flow channel through at least one receiving channel, detecting at least one optical signal from the illuminated droplet by at least one signal detector coupled to plurality of receiving channels, analysing the detected optical signal to determine at least one property of contents of the droplet.

12. The method of claim 11, wherein a droplet in the analyte flow channel is illuminated by a single optical source through plurality of illuminating channels such that the droplet is subjected to plurality of interrogations by same wavelength of the optical source at plurality of locations, and wherein the interrogations are separated by a time delay based on flow rate of the droplet across the locations.

13. The method of claim 11, wherein the optical signals from an illuminated droplet comprises a plurality of optical wavelengths.

14. The method of claim 11, wherein flow rate of a droplet is optimized by a feedback control configured to optimize flow rate of the droplet based on at least one optical signal detected from an illuminated droplet.

15. The method of claim 11, wherein plurality of optical signals is successively interrogated at plurality of locations traversed by a droplet and the plurality of optical signals from the droplet are analysed by combining the plurality of optical signals into a detector.

16. The method of claim 15, wherein flow rate of droplets is optimized to interrogate optical signals from successive droplets such that a droplet is interrogated after a succeeding droplet has traversed all the plurality of locations of interrogation.

17. The method of claim 11, wherein the analyte is selected from a group comprising blood cells, single cells from culture cell lines, serum, bacteria, contaminants in liquid, fluorescently labeled cells, beads, microparticles, fluorescently tagged cell organelles, fluorescently tagged nucleic acid probes, and fluorescently tagged nucleic acid proteins.

18. The method of claims 11, wherein the buffer is selected from a group comprising oils, surfactants and emulsifiers.
